(19) United States
(12) Patent Application Publication
(10) Pub. No.: US 2007/0162855 A1
(43) Pub. Date: Jul. 12, 2007

(54) Movie authoring

(76) Inventors: Kelly Hawk, San Francisco, CA (US); Michael Leong, Cupertino, CA (US); Keith Salvucci, Belmont, CA (US); James Brasure, Belmont, CA (US); Greg Mullins, Boulder Creek, CA (US); Jeff Robbin, Los Altos, CA (US)

Correspondence Address: FISH & RICHARDSON P.C., PO BOX 1022, MINNEAPOLIS, MN, 55440-1022, US

(21) Appl. No.: 11/327,305

(22) Filed: Jan. 6, 2006

(51) Int. Cl. G06F 9/00

(52) U.S. Cl. 715/730; 715/731; 715/732

(57) ABSTRACT

A movie authoring process is disclosed which includes: selecting a theme, determining theme elements based on the theme selection, and adding the theme elements to a movie. An automated movie authoring process is also disclosed which includes: automatically capturing raw video footage from a video source; automatically dividing the raw video footage into video clips, wherein the video clips collectively constitute a movie; automatically determining one or more theme elements from a plurality of theme elements based on a selected theme; and automatically adding the one or more determined theme elements to the movie.

### RELATED APPLICATIONS

The subject matter of this application is related to co-pending U.S. patent application Ser. No. 10/742,957, entitled “Creating a Theme Used By An Authoring Application To Produce A Multimedia Presentation,” filed Dec. 22, 2003; U.S. patent application Ser. No. 10/337,907, entitled “Method and Apparatus For Producing A Packaged Presentation,” filed Jan. 6, 2003; and U.S. patent application No. ______, entitled “Controlling Behavior of Elements In A Display Environment,” filed Jan. 6, 2006, Attorney Docket No. 18814-020001. Each of these applications is incorporated herein by reference in its entirety.

### TECHNICAL FIELD

The disclosed implementations relate generally to movie authoring applications.

### BACKGROUND

Advancements in computer technology have made it possible to create professional quality multimedia projects on personal computers. For example, movie authoring applications, such as iMovie® developed by Apple Computer, Inc. (Cupertino, Calif.), provide users with a suite of tools for capturing and editing video. A user can import into a personal computer raw video footage captured by a video camera. The user can edit the footage from within the movie authoring application by adding titles, transitions, graphics, background music, effects, etc. While some users enjoy the process of movie authoring and are willing to invest the time and energy into understanding the full capabilities of a movie authoring application, there are other users who would prefer to have at least some authoring tasks simplified or automated.

### SUMMARY

The deficiencies of conventional movie authoring applications are overcome by the disclosed implementations summarized below.

In some implementations, a method of authoring movies includes: receiving a theme selection; determining theme elements based on the theme selection; receiving a theme element selection; and adding the selected theme element to a movie.

In some implementations, a user interface for authoring movies includes a first display area for displaying theme elements for selection, and a second display area for adding selected theme elements to a movie.

In some implementations, a method of authoring a movie includes: automatically capturing raw video footage from a video source; automatically dividing the raw video footage into video clips, wherein the video clips collectively constitute a movie; automatically determining one or more theme elements from a plurality of theme elements based on a selected theme; and automatically adding the one or more determined theme elements to the movie.

Other implementations are described herein, including but not limited to implementations related to systems, methods, computer-readable mediums, computer program products, apparatuses, devices and data structures.

### BRIEF DESCRIPTION OF DRAWINGS

FIG. 1 is a screenshot of an implementation of a user interface for a movie authoring application.

FIG. 2 is a screenshot of an implementation of a drop zone editor 200 for displaying drop zone content.

FIG. 3 is block diagram illustrating drop zone areas in a theme element.

FIG. 4 is a screenshot of an implementation of a user interface for a movie authoring application showing the addition of theme elements to a movie.

FIG. 5 is screenshot of an implementation of a user interface for a movie authoring application, including a pane for selecting media for incorporation into theme elements.

FIG. 6 is screenshot of an implementation of a user interface for a movie authoring application, including a pane for displaying video effects for incorporation into theme elements.

FIG. 7 is a screenshot of an implementation of a user interface for a movie authoring application, including a pane for displaying audio effects for incorporation into theme elements.

FIG. 8 is a screenshot of an implementation of a user interface for a movie authoring application, including a window for receiving input for an automated movie authoring process.

FIG. 9 is a screenshot of an implementation of user interface for a movie authoring application, including a window for receiving music selections for an automated movie authoring process.

FIG. 10 is a flow diagram of an implementation of an automated movie authoring process.

FIG. 11 is a block diagram of an implementation of an operating environment for a movie authoring application.

FIG. 12 is a block diagram of an implementation of a user system architecture for hosting a movie authoring application.

### DETAILED DESCRIPTION

### Movie Authoring Application

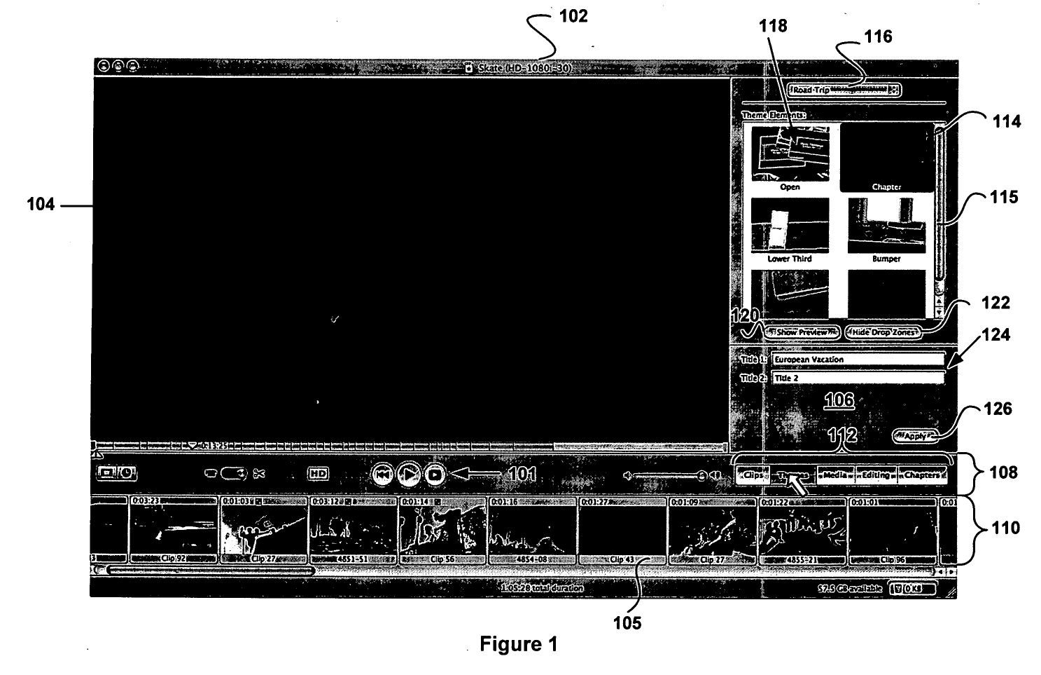

FIG. 1 is a screenshot of an implementation of a user interface 102 for a movie authoring application (e.g., iMovie®). The user interface 102 includes a display area 104, a theme pane 106, a control area 108 and a timeline 110. The display area 104 is for displaying multimedia content, such as video clips, graphics, overlays, transitions, compositions, etc. Content can be imported into the authoring application using a standard communication port (e.g., FireWire®, Universal Serial Bus (USB), etc.), and/or created from within the movie authoring application. In FIG. 1, the display area 104 is displaying the first frame of video clip 105 (“clip 43”).

A “clip” is a sequence of video frames. A user can view the individual frames of a video clip by clicking on one or more control buttons 101 (e.g., play, fast forward, reverse, pause, stop, etc.) in the control area 108. In some implementations, the control area 108 also includes buttons 112 for switching between panes associated with clips, themes, media, editing and chapters. The theme pane 106 is currently displayed in FIG. 1.

In some implementations, the theme pane 106 includes a scrollable viewer 115 for displaying theme elements 114, which are related to a theme selected by a user through a theme menu 116 (e.g., a “Road Trip” theme). A theme element can be added to a movie as a transition, overlay, background, composition, etc. Theme elements 114 include one or more objects that have properties (e.g., color schemes, fonts, styles, etc.). At least some objects in a theme element are graphics 118 that can include static or animated drop zone areas (also referred to as “drop zones”) for displaying content (e.g., still images, video clips, text, etc.). For example, a holiday theme element may incorporate orange and black graphics depicting traditional Halloween elements (e.g., pumpkins, ghosts, witches, etc.). The graphic 118 could include a drop zone for showing a photo taken by a user at a Halloween party.

Any number and types of theme elements are possible, including but not limited to theme elements related to life events (e.g., marriage, children, school plays, proms, music recitals, graduation, birthdays, etc.), holidays, seasons, sporting events, business functions, travel, music, hobbies, etc.

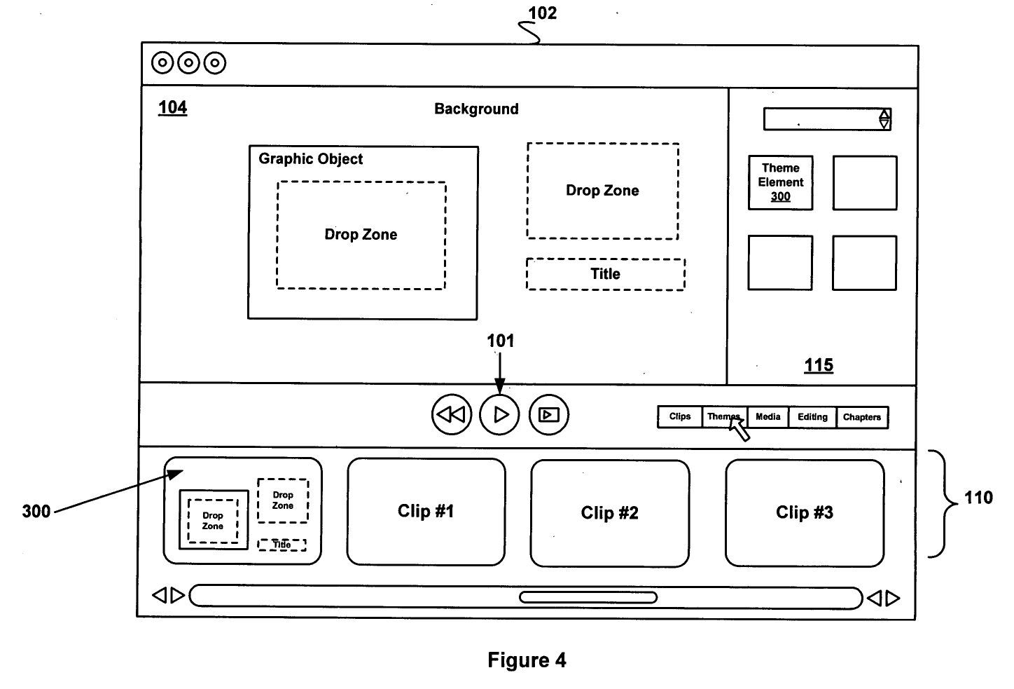

Theme elements 114 can be selected and dragged from the viewer 115 (e.g., clicked or mouse over) and dropped into the timeline 110 at one or more desired locations, as described with respect to FIG. 4. When the movie is rendered, the theme element will be added to the movie at the selected location. Examples of timeline locations include the beginning or ending of a movie, at chapter markers or between scenes (i.e., a transition). Theme elements 14 can also be overlaid onto one or more frames of a clip. For example, a theme element 114 can be overlaid onto a percentage of a frame (e.g., the lower third), so that only a portion of the frame is obscured by the theme element 114. Theme elements 114 can include a variety of objects and content, including but not limited to: graphics, still images, video, audio, video or audio effects, text, titles, user interface elements (e.g., buttons, menus, etc.). In some implementations, theme elements 14 can include one or more static or dynamic drop zone areas 118 for displaying content. For example, a user can select a single image to be displayed in a static drop zone area 118, or a series of images to be displayed as a slide show. A user can select a video clip to be displayed in a drop zone area 118, which can be played for a predetermined number of seconds before looping. In some implementations, a mix of content can be displayed in a single drop zone area 118. For example, one or more still images can be displayed in the drop zone area 118, followed by one or more video clips 105, etc.

In some implementations, the theme pane 106 includes a button 120 or other input mechanism for initiating a preview of a theme element 114, so that a user can instantly see how the theme element will look in the context of the movie. A button 122 or other input mechanism can also be included in the theme pane 106 to hide drop zone areas 118, thus enabling the user to use theme elements 114 with or without drop zone areas 118. In some implementations, the theme pane 106 includes one or more text boxes 124 for inserting opening titles and subtitles. In some implementations, the titles are text objects that are incorporated into the theme element 114 when the user clicks button 126.

In sum, the theme pane 106 and theme elements 114 described above provide a user with a simple and intuitive user interface for authoring a movie. The user selects a theme from the theme menu 116, which results in the presentation of theme elements 114 that are related to the selected theme. The user selects one or more theme elements 114 to be added to the movie. The user can preview the theme elements in real-time and make any adjustments to the theme elements (e.g., change drop zone content, apply effects, etc.) prior to rendering the movie to a file. When finished adding theme elements, the user can render the movie to a file.

### Drop Zone Editing

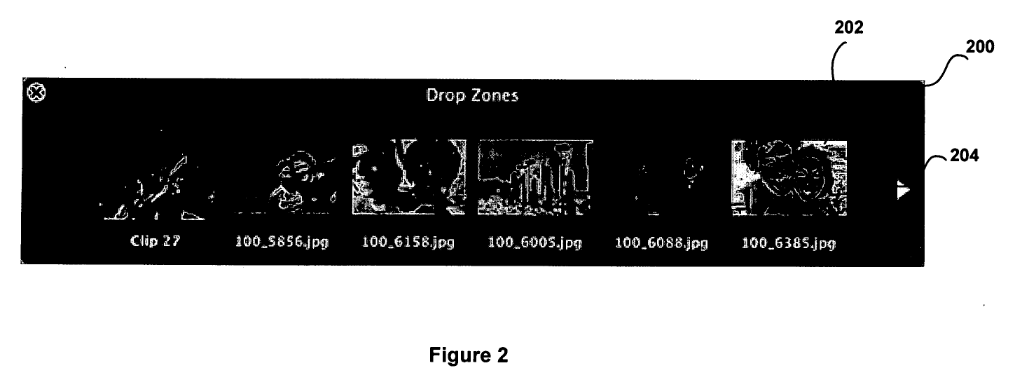

FIG. 2 is a screenshot of an implementation of a drop zone editor 200 for displaying content 202 that was added to available drop zones in a theme element. The drop zone editor 200 allows a user at a glance to see the content of drop zones for a theme element. The user can scroll through the available drop zones for a theme element using controls 204. In some implementations, the drop zone editor 200 is a single window that can be invoked through a menu or other input mechanism, or by double clicking on a theme element in the theme viewer 115.

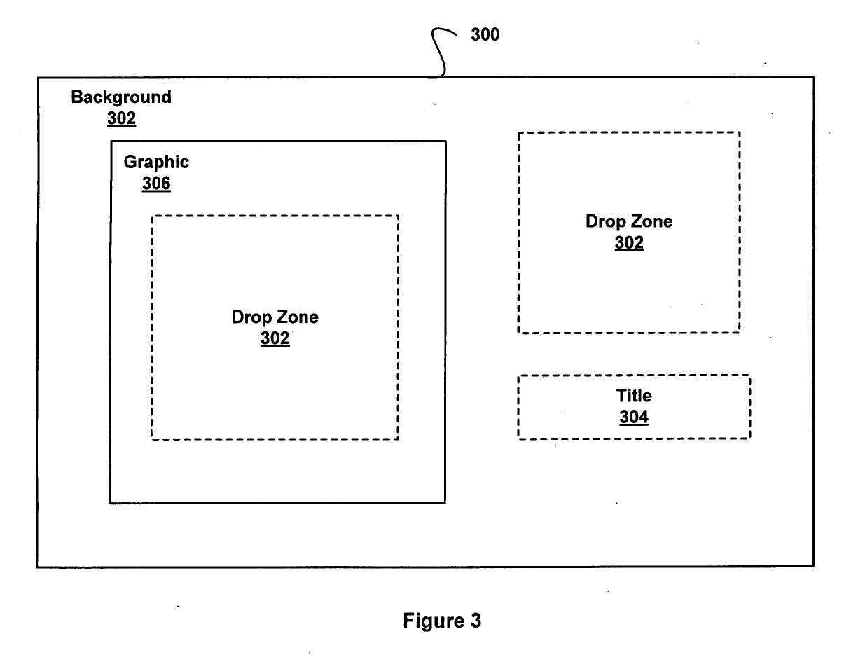

FIG. 3 is block diagram illustrating drop zones 302 in a theme element 300. In some implementations, the theme element 300 includes one or more drop zones 302 and a title 304 overlaying a background 302. The drop zones 302 can be part of a graphic 306 or can be displayed separately on the background 302. In some implementations, at least one drop zone 302 is displayed on an animated graphic 306 that is programmed to follow a motion path in the background 302. In other implementations, at least one drop zone 302 is animated to follow a motion path against in the background 302. The background 302 can include one or more thematic graphics or images, some of which can be animated. In some implementations, the content is positioned, oriented and zoomed in the drop zones according to default values, which can be based on one or more properties of the drop zone (e.g., size, orientation, etc.). The drop zone editor enables a user to add, remove, rearrange and reposition content in drop zones and to set a desired zoom level if the default values provided by the drop zone editor are not satisfactory.

Various techniques for animating drop zones to follow a motion path are described in co-pending U.S. patent application No. ______, entitled “Controlling Behavior of Elements In A Display Environment,” filed Jan. 6, 2006, Attorney Docket No. 18814-020001.

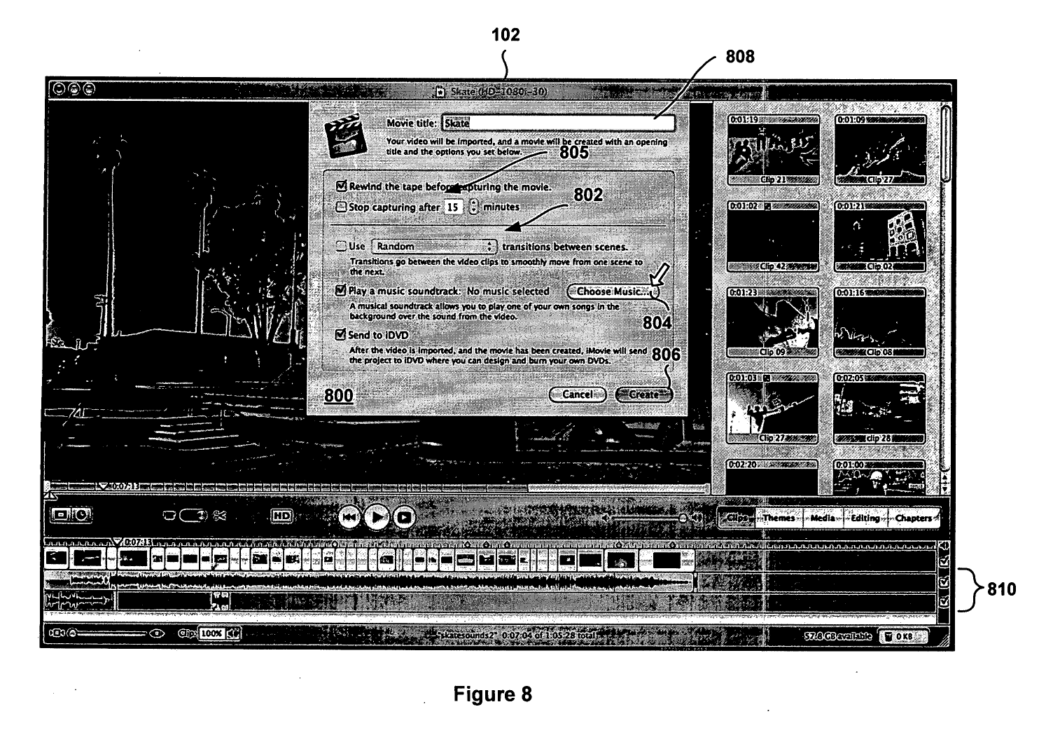

In some implementations, content for display in drop zones 302 can be selected and dragged from a pane, folder, viewer or menu, and dropped in the drop zones 302. Alternatively, the content can be selected automatically by a movie authoring application or an operating system, as described with respect to FIGS. 8-10. In some implementations, the content is immediately displayed in the drop zone area 302 after being dropped, so that the user can instantly determine how the content would appear to a viewer, and whether other further customizations or edits are desired (e.g., different theme element, drop zone content, etc.).

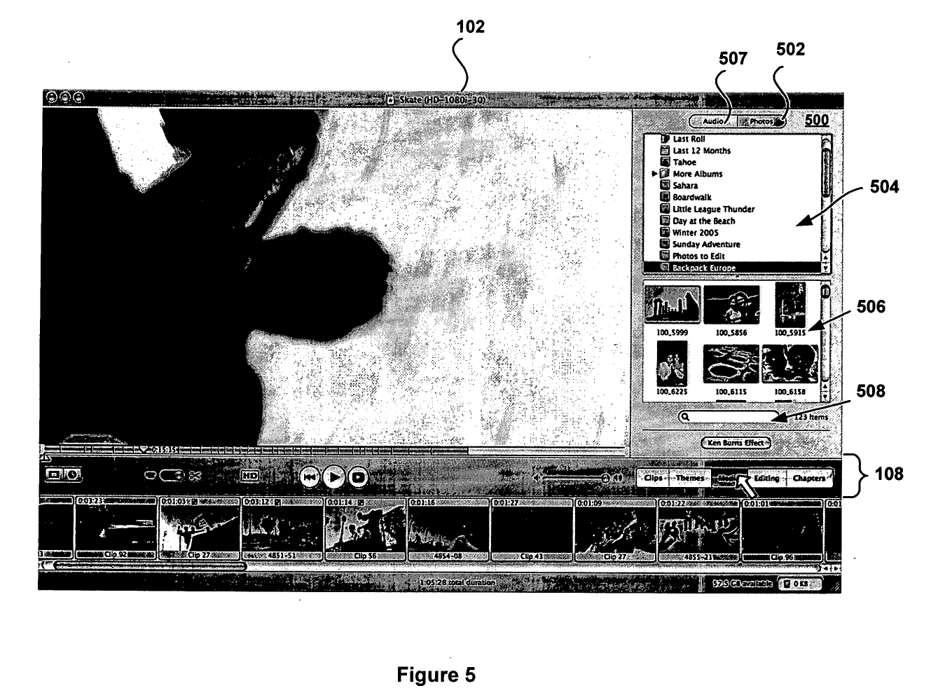

FIG. 4 is a screenshot of an implementation of a user interface 102 for a movie authoring application showing the addition of theme elements in a movie. In this example, the user has dragged the theme element 300 from the viewer 115 and dropped it in the timeline 110, immediately before Clip #1. When the theme element 300 is dropped into the timeline 110 it is automatically displayed in the display area 104. The user can then press the play button 101 or other input mechanism to view the theme element 300 together with the other video clips in the timeline 110. If the user is not satisfied with the theme element 300 or its location in the timeline 110, the user can drag and drop the theme element 300 to a different location in the timeline 110 and/or select a different theme element from the viewer 115. The user can also change the content of any drop zones in the theme element 300, as described with respect to FIG. 5.

### Selecting Media Content

FIG. 5 is screenshot of an implementation of a user interface 102 for a movie authoring application, including a media pane 500 for selecting media content for incorporation into theme elements, as described with respect to FIGS. 3 and 4. The media pane 500 can be invoked by clicking on a “Media” button 108 or other input mechanism. The media pane 500 includes a media viewer 504, a media display area 506 and a media browser 508. In some implementations media includes audio media (e.g., songs, sound effects, etc.) and visual media (e.g., photos, video clips, etc.). In the exemplary configuration shown in FIG. 5, a photo button 502 was selected, causing a directory of folders containing photos to be displayed in the media viewer 504. When a folder is selected in the media viewer 504, the photos in the selected folder are displayed in the media display area 506. The pane 500 also includes a media browser 508 for searching for media content on local storage devices and/or on a network (e.g., Internet, Ethernet, wireless, etc.). In some implementations, the user (or an application or operating system) can select one or more photos displayed in the display area 504, and drag the photos into one or more drop zones of a theme element. In some implementations, a folder of photos can be dragged and dropped into a drop zone, and the photos will be displayed as a slide show based on the location of the photos in the folder or some other sequence (e.g., randomly) selected by the user through a preference pane or other input mechanism.

An audio button 507 opens a directory of folders containing audio files (e.g., .wav, MP3, etc.). When a folder is selected its contents are presented in the display area 506. The user (or an application or operating system) can select one or more audio files from the display area 506 to be added to the movie as a soundtrack. The user can also use the media browser 508 to search a local song library and/or catalog accessible through a network connection (iTunes®). The user can select and drag a song from the viewer 504 or the display area 506 and drops the song into an audio timeline (e.g., the audio timelines 810 shown in FIG. 8.).

### Editing Movie Elements

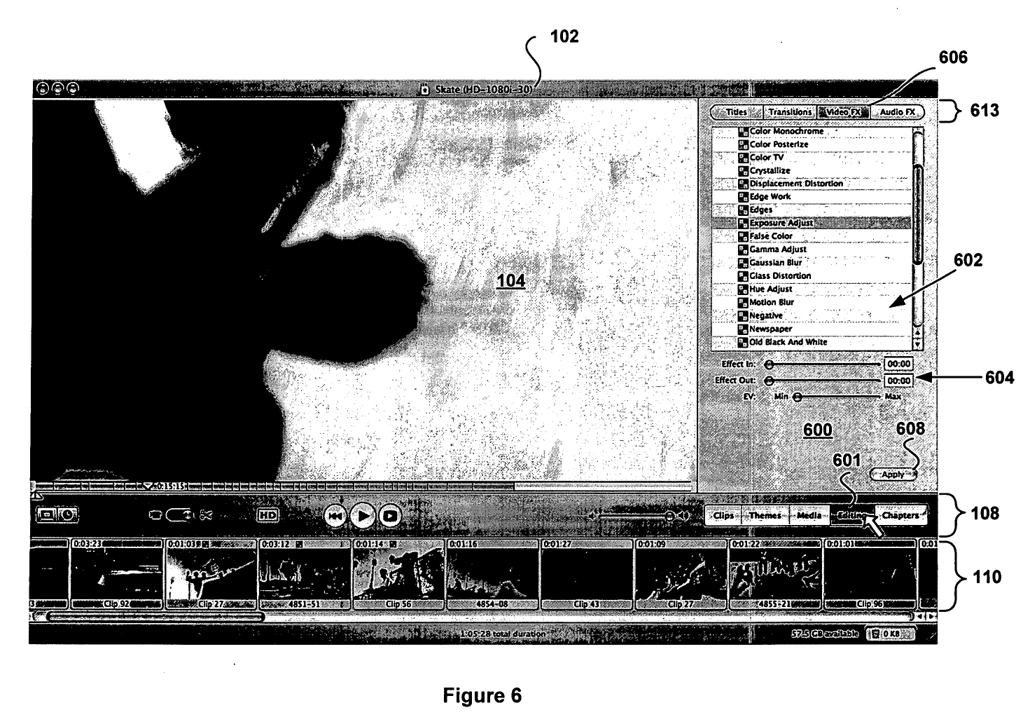

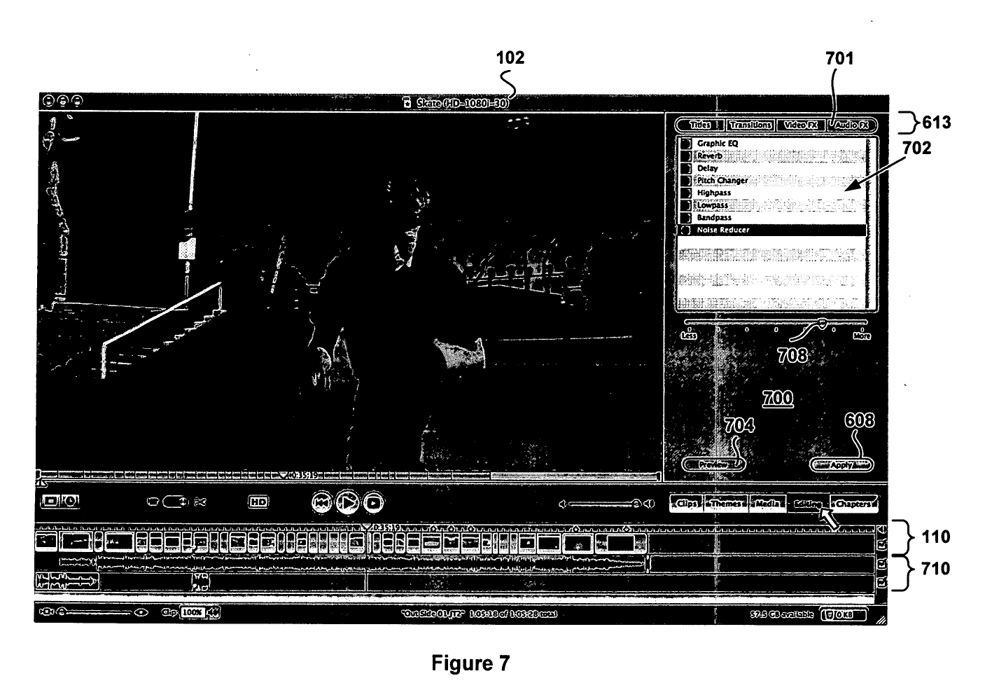

FIG. 6 is screenshot of an implementation of a user interface 102 for a movie authoring application, including an editing pane 600 for displaying various movie elements that can be edited (e.g., titles, transitions, video and audio effects). The editing pane 600 can be invoked by clicking on the “Editing” button 601 in the control area 108. In some implementations, a video FX button 606 in a navigation bar 603 can be clicked causing a video effects viewer 602 to be presented. The viewer 602 lists various video effects (e.g., color monochrome, color posterize, color TV, etc.) that can be applied to clips or theme elements in the timeline 110. The user can highlight the clip or theme element for receiving the video effect, then selecting one or more video effects from the viewer 602 and clicking the apply button 608. In some implementations, the editing pane 600 includes one or more controls 604 (e.g., scrollbars) for adjusting the start and stop times for the effect and for controlling the amount of video effect that is applied. By selecting other buttons in the navigation bar 603, additional movie elements and effects are presented for selection and application to clips and/or theme elements, including but not limited to: titles, transitions and audio effects. For example, clicking on the “Titles” button will display one or more text boxes for entering a title and subtitle. Clicking on the “Transitions” button will display a list of available transition effects that can be inserted in the movie (e.g., dissolve, fade in/out, etc.). Clicking on the “Audio FX” button will display a list of audio effects that be applied to captured audio, as described with respect to FIG. 7.

In some implementations, video content displayed in a drop zone of a theme element can be processed with video effects by selecting the theme element in the timeline 110 and the desired effect. The theme element can be selected by clicking the theme element in the timeline 110. When selected the theme element will become highlighted in the timeline 110 to indicate its selected status. It will also be displayed in the display area 104. In response to clicking the “Apply” button 608, the selected video effects will be applied to any video clips that are looping in drop zones of the selected theme element.

FIG. 7 is a screenshot of an implementation of a user interface 102 for a movie authoring application, including an audio pane 700 for displaying audio effects that can be applied to captured audio. When the user clicks on the Audio FX button 701 or other input mechanism a list 702 of audio effects is displayed in the audio pane 700. These effects include but are not limited to: a graphic EQ, reverb, delay, a pitch changer, a high pass filter, a low pass filter, a band pass filter and a noise reducer. Based on the audio effect that is selected, a set of controls for controlling the application of the audio effect to capture audio is displayed in the audio pane 700. For example, a graphic equalizer (EQ) would display controls for adjusting signals over multiple frequency bands. The noise reducer would display a control 708 (e.g., a scroll bar) for adjusting a noise threshold to eliminate unwanted background noise (e.g., wind, traffic, beach noise, etc.) from captured audio. Another notable effect is the pitch changer which would display controls for changing the pitch of an audio signal without changing the time duration of the signal.

In some implementations, the user can preview in real-time the application of audio effects to captured audio by, for example, clicking a preview button 704 or other input mechanism. When the desired amount of effect is reached, the user can click on the “Apply” button 706 or other input mechanism to apply the effect to the captured audio.

Note that in some implementations the captured audio is displayed in stereo audio regions 810 to facilitate editing. A portion of the audio signal to receive the audio effect cant be highlighted in the audio regions 710 with the mouse. When the user clicks the “Apply” button 706, the effect is applied to the selected audio signal. For example to apply audio effects to audio that is playing during a theme element, the portion of audio signal in the audio region 710 underlying the theme element in the timeline 110.

### Automated Movie Authoring Process

FIG. 8 is a screenshot of an implementation of a user interface 102 for a movie authoring application, including a window 800 for receiving input for use with an automated movie authoring process. The automated movie authoring process automatically creates a movie from raw video footage, which includes titles, chapter markers, transitions, soundtrack, theme elements, etc.

The user can invoke the window 800 from a menu or other input mechanism (e.g., a button). The window 800 includes a text box 808 for adding a custom title for the movie. The user can select video capture options using check boxes 805. For example, a user can select an option to rewind the videotape before capturing the movie. In some implementations, the user's video camera is connected to the authoring application through a standard port (e.g., FireWire®, USB, etc.). The transport controls of the video camera can be controlled by the authoring application to rewind the videotape before importing the video footage into the authoring application. In some cases, the user may select the amount of video footage to import by selecting the appropriate check box 805 to stop capturing after a user-selectable amount of time (e.g., 15 minutes, etc.).

The window 800 includes an input mechanism 802 (e.g., menu, check box, etc.) for selecting transitions between scenes. Examples of transitions include but are not limited to: random, circle opening, circle closing, cross dissolve, overlap, push, radial, scale, down, etc. Selecting the random parameter will cause transitions to be selected at random from a library of available transitions and added at one or more clip boundaries.

In some implementations, theme elements (e.g., transitions, overlays, compositions, etc.) are automatically selected based on a theme selected by the user or the authoring application. For example, if a Christmas theme is selected, then Christmas theme elements are automatically selected for adding to the movie. The Christmas theme elements can be added at the beginning or end of the movie, at chapter markers or scene transitions, or at any other suitable clip boundaries in the movie.

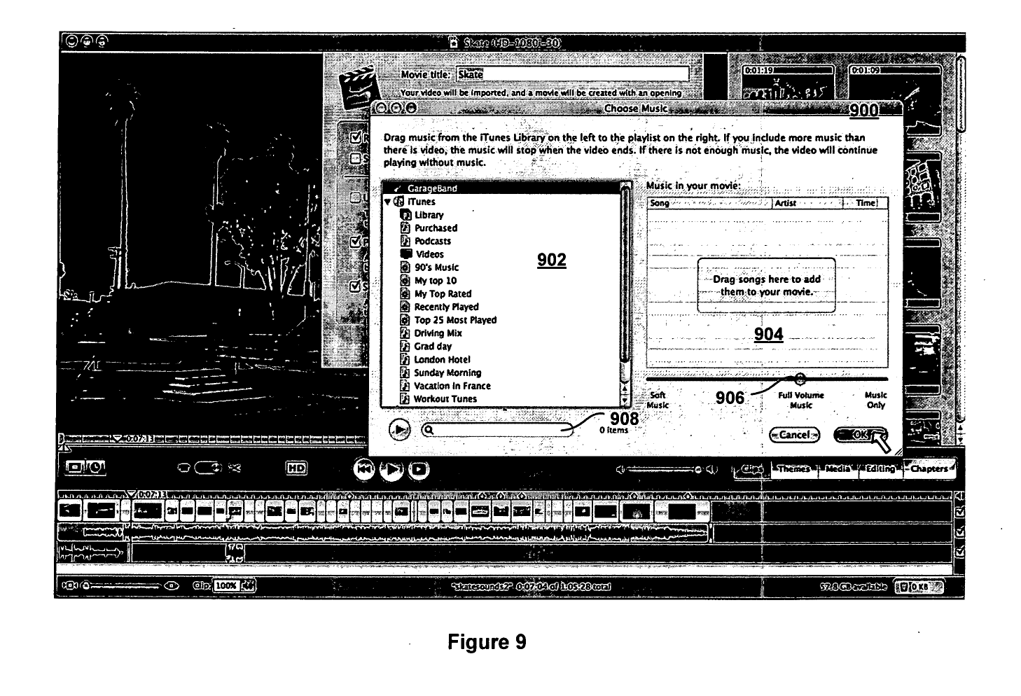

The window 800 also includes an input mechanism (e.g., check box) for selecting and adding a music soundtrack to a movie. In some implementations, a user can click a button 804 or other input mechanism to invoke a content management application (e.g., iTunes®), which can provide access to a library of songs. In some implementations, a file system integrated in the content management application allows users to organize and manage content (e.g., songs, photos, videos, etc.), as shown in FIG. 9. In some implementations, where the content management application is invoked from the authoring application a viewer 902 is displayed. The viewer 902 displays folders containing songs from which a song can be selected as a soundtrack for the movie. In some implementations, the user can use a search engine 908 (e.g., Safari®, Spotlight®, Google®, etc.) to find music stored locally or remotely on a network (e.g., Internet). The user can select one or more songs to be part of the movie soundtrack by dragging songs from the viewer 902 into a display area 904. In some implementations, a volume control mechanism 906 is provided for adjusting the volume of the music soundtrack to a desired level (e.g., soft, full volume, etc.).

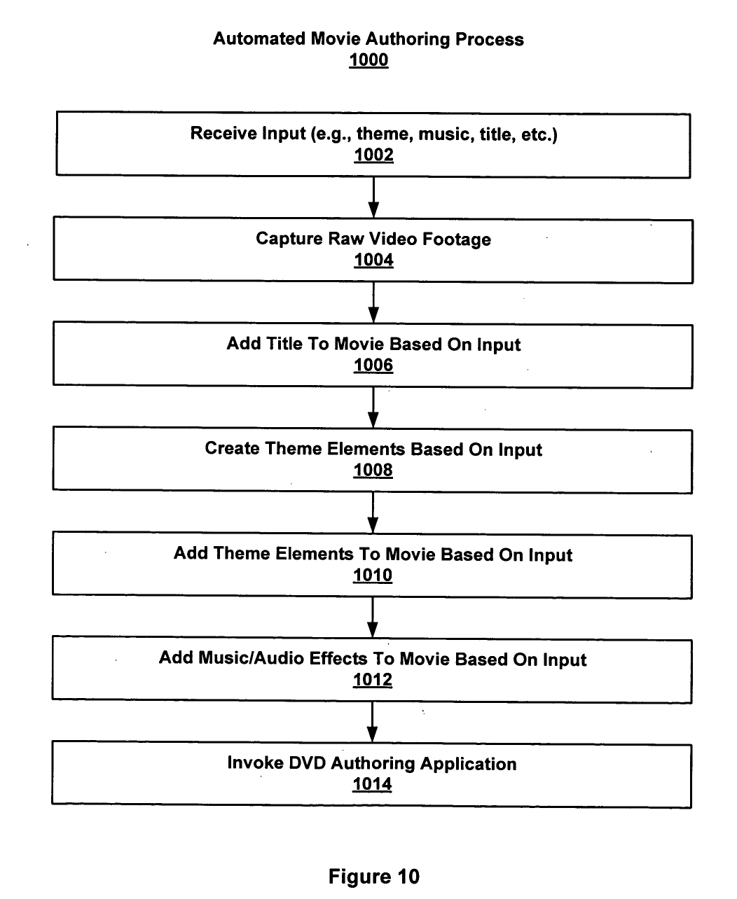

FIG. 10 is a flow diagram of an implementation of an automated movie authoring process 1000. The steps of process 1000 do not have to occur in a specific order and at least some steps can occur simultaneously in a multithreading or multiprocessing environment.

The process 1000 begins in response to input received from a user or from an application or operating system (1002). In some implementations, the process 1000 begins in response to a user pressing the “Create” button 806 in window 800 shown in FIG. 8. The process 1000 automatically captures raw video footage from a video source (e.g., videotape, file, etc.). If a video camera is connected to the authoring application, then depending on the settings selected by the user, the videotape in the video camera is rewound and the raw video footage is captured into a file for use by the authoring application (1004).

After the raw video is captured, the process 1000 automatically adds a title to the movie (1006) and automatically creates theme elements (e.g., transitions, overlays, compositions, etc.) based on the received input (1008). In some implementations, video effects are added to the theme elements. After the theme elements are created, the theme elements are automatically added to the movie (1010). The theme elements can be added at various locations in the movie timeline (e.g., chapter markers, scene transitions, etc.). A music soundtrack is then automatically added to the movie based on the received input (1012). In some implementations, sound effects can also be added to the movie. When the movie elements (e.g., title, theme elements, music, etc.) have been created and added to the movie, the process 1000 automatically renders the movie to a file. In some implementations, the process 1000 automatically invokes a Digital Versatile Disk (DVD) authoring application (1014). The DVD authoring application can be used to create custom DVD menus, as described in U.S. patent application Ser. No. 10/742,957, entitled “Creating a Theme Used By An Authoring Application To Produce A Multimedia Presentation,” and U.S. patent application Ser. No. 10/337,907, entitled “Method and Apparatus For Producing A Packaged Presentation.”

### Movie Authoring Application Environment

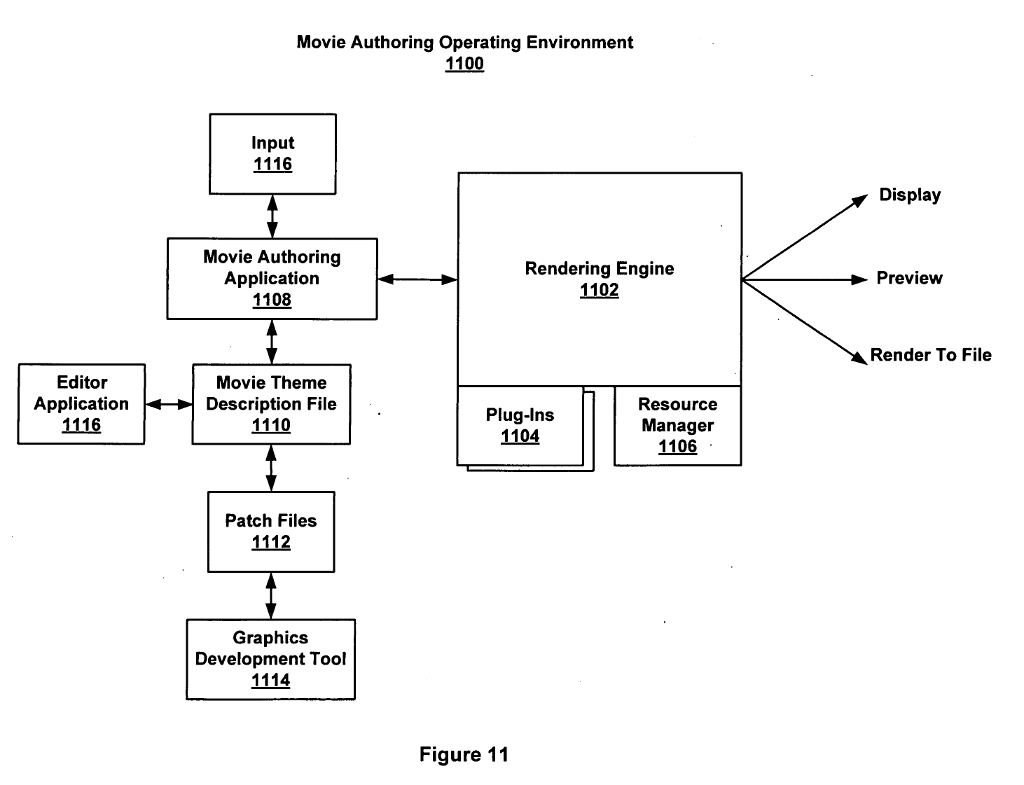

FIG. 11 is a block diagram of an implementation of an operating environment 1100 for a movie authoring application 1108. The movie authoring application 1108 receives a movie theme description file 1110 and user input 1116 and interacts with a rendering engine 1102 to produce, display, preview or render a movie, as described with respect to FIGS. 1-10.

Each theme element (e.g., a transition, overlay, composition, etc.) includes one or more objects having various properties. The theme description file 1110 contains a description of each theme element used in a movie (e.g., graphics, content, overlay, composition, colors, fonts, sizes, alignment, etc.), including descriptions of objects and object properties. For example, drop zones are objects that can be defined in the theme description file 1110 by various properties, including but not limited to: position, area size (defined by a bounding box), orientation, transparency level, depth, etc.

In some implementations, the theme description file 1110 includes a path to one or more patch files 1112 for each object (or component of an object) of a theme element for use in rendering the object. The patch files 1112 associated with an object contains descriptions of modules having specific functions that are used to render the object. The rendering engine 1102 reads and determines a specific function called for by a module in a patch file 1112 and calls and executes a plug-in program 1104 capable of performing the specific function. In some implementations, the description file 1110 and the patch files 1112 are Extensible Markup Language (XML) files, which can be edited with an editing application 1118 (e.g., the XML Editor developed by <oxygen/>). In some implementations, the patch files 1112 are created by a graphics development tool 1114 for processing and rendering graphical data, such as Quartz Composer™ provided with Apple Computer Inc.'s Mac OS® X v10.4 (“Tiger”) operating system. A technique for creating patch files using a composer application is described in U.S. patent application Ser. No. 10/742,957, entitled “Creating A Theme Used By An Authoring Application To Produce A Multimedia Presentation.”

In some implementations, the theme description file 1110 can be part of a bundle (e.g., a folder of files) that contains “content” files (e.g., still images, video clips, etc.) to be displayed in objects of a theme element. For example, if a default graphic is to be displayed in an object of a theme element (e.g., displayed in a drop zone area), the description file 1110 provides the patch file(s) 1112 needed to render the object with a path to the default graphic.

A patch file 1112 can also be part of a bundle (e.g., a folder of files) that contains “content” used to render objects, such as graphics or animations. In some implementations, the patch bundle is a subfolder in the description file bundle described above.

A movie is produced by the rendering engine 1102 using the descriptions in the theme description file 1110, together with any user input 1116 received through the movie authoring application 1108, and the patch files 1112 referred to in the theme description file 1110. To render a particular object of a theme element, the rendering engine 1102 loads and reads the patch file 1112 specified for the particular object in the theme description file 1110.

To render a theme element, the rendering engine 1102 can use one or more plug-ins 1104. A plug-in 1104 is a program that implements a specific operation specified by the description file 1110 or a module in a patch file 1112. For example, a plug-in 1104 may be used to import a graphic or text into the rendering engine 1102 or to implement a special effect (e.g., sepia tone, filtering, etc.) on an imported graphic, as called for in the description file 1110 or a patch file 1112. A plug-in is called or invoked and executed by the rendering engine 1102 when needed. In some implementations, the rendering engine 1102 also uses a resource management program 1106 to manage resources used by the plug-ins 1104 (e.g., memory allocation, processor time, etc.).

### Rendering Engine Operation

In some implementations, the rendering engine 1102 uses a global compositing stack (object hierarchy) that contains layers of objects. The ordering of layers in the global compositing stack can be specified in the theme description file 1110. The theme description file 1110 can also include, for each object layer, a path to a patch file 1112 for rendering the object layer. The movie authoring application 1108 reads the description file 1110 and sends the object layer ordering and associated patch file paths to the rendering engine 1102. As each patch file path is received by the rendering engine 1102, an object layer is created in the global compositing stack. The rendering engine 1102 then composites the objects accordingly to produce the rendered theme element.

In some implementations, the rendering engine 1102 renders objects starting from the bottom object layer to the top object layer, so that objects on upper layers are displayed on top of objects on lower layers. For example, an object layer above a lower object layer in the object global compositing stack can be rendered opaque while the lower object layer is rendered transparent when both object layers occupy the same area in the theme element. In some implementations, the rendering engine 1102 reads the patch file 1112 for multi-component objects and uses a separate compositing stack for rendering each component of the object.

A technique for rendering drop zones is described in U.S. patent application Ser. No. 10/742,957, entitled “Creating A Theme Used By An Authoring Application To Produce A Multimedia Presentation.”

### User System Architecture

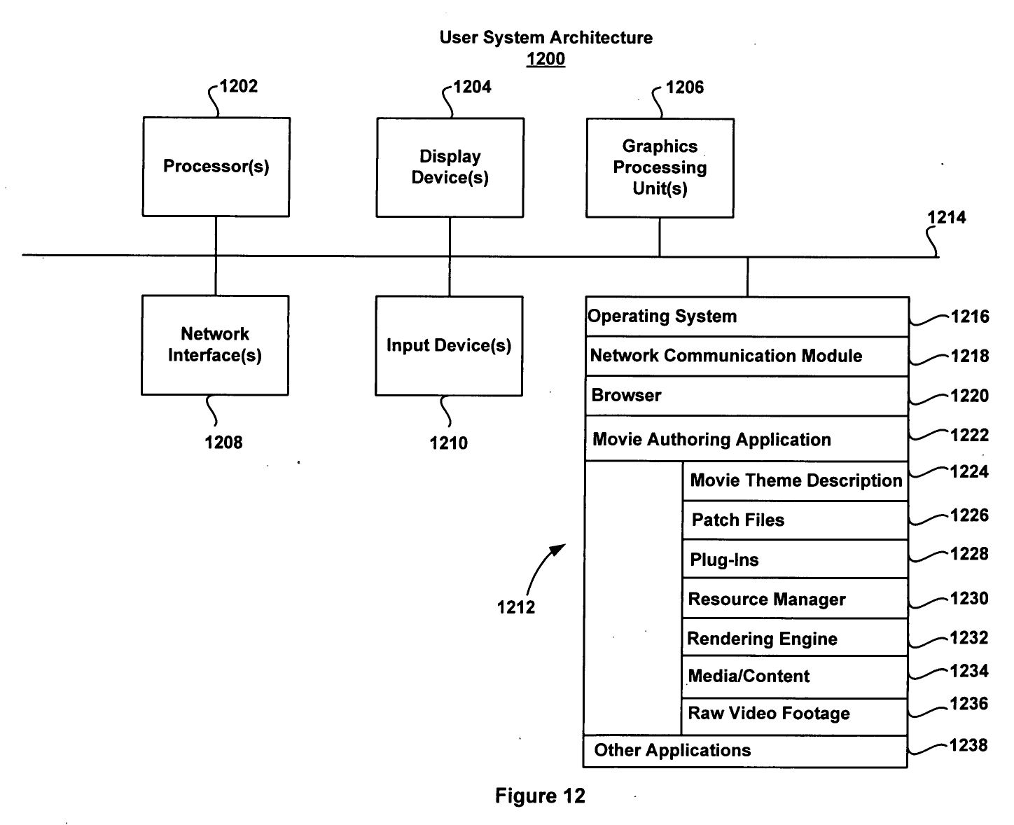

FIG. 12 is a block diagram of a implementation of a user system architecture 1200 for hosting a movie authoring application. The architecture 1200 includes one or more processors 1202 (e.g., IBM PowerPC®, Intel Pentium® 4, etc.), one or more display devices 1204 (e.g., CRT, LCD), one or more graphics processing units 1206 (e.g., NVIDIA Quadro FX 4500, GeForce 7800 GT, etc.), one or more network interfaces 1208 (e.g., Ethernet, FireWire, USB, etc.), one or more input devices 1210 (e.g., keyboard, mouse, etc.), and one or more computer-readable mediums 1212 (e.g. SDRAM, optical disks, hard disks, flash memory, L1 or L2 cache, etc.). These components exchange communications and data via one or more buses 1214 (e.g., EISA, PCI, PCI Express, etc.).

The term “computer-readable medium” refers to any medium that participates in providing instructions to a processor 1202 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 1212 further includes an operating system 1216 (e.g., Mac OS®, Windows®, Linux, etc.), a network communication module 1218, a browser 1220 (e.g., Safari®, Microsoft® Internet Explorer, etc.) and a movie authoring application 1222. The movie authoring application 1222 further includes a movie theme description file 1224, patch files 1226, plug-ins 1228, a resource manager 1230, a rendering engine 1232, media/content 1234 (e.g., video/audio effects, still images, graphics, etc.) and raw video 1236. Other applications 1238 can includes any other applications residing on the user system, such as a graphics development tool (e.g., Quartz Composer®), an XML editor, or any other applications related to the movie authoring process (e.g., iTunes®, email, etc.), previously described.

The operating system 1216 can be multi-user, multiprocessing, multitasking, multithreading, real-time and the like. The operating system 1216 performs basic tasks, including but not limited to: recognizing input from input devices 1210; sending output to display devices 1204; keeping track of files and directories on computer-readable mediums 1212 (e.g., memory or a storage device); controlling peripheral devices (e.g., disk drives, printers, GPUs 1206, etc.); and managing traffic on the one or more buses 1214. The network communications module 1218 includes various components for establishing and maintaining network connections (e.g., software for implementing communication protocols, such as TCP/IP, HTTP, Ethernet, etc.). The browser 1220 enables the user to search a network (e.g., Internet) for information (e.g., digital media items) and/or the user system (e.g., Safari®, Spotlight®). The movie authoring application 1222, together with its components, implements the various tasks and functions, as described with respect to FIGS. 1-11.

A user systems can be any electronic or computing device capable of hosting a movie authoring application, including but not limited to portable or desktop computers, workstations, network servers, etc.

Various implementations have been described. These implementations can be modified and still remain within the scope of the following claims.

What is claimed is:

1. A method of authoring movies, comprising:
receiving a theme selection;
determining theme elements based on the theme selection;
receiving a theme element selection; and
adding the selected theme element to a movie.

2. A user interface for authoring movies, comprising:
a first display area for displaying theme elements for selection; and
a second display area for adding selected theme elements to a movie.

3. The user interface of claim 2, wherein the second display area is a timeline.

4. The user interface of claim 2, wherein at least one theme element includes a drop zone.

5. The user interface of claim 4, wherein the drop zone is animated.

6. The user interface of claim 2, further comprising a third display area for displaying drop zone content.

7. A method of authoring a movie, comprising:
automatically capturing raw video footage from a video source;
automatically dividing the raw video footage into video clips, wherein the video clips collectively constitute a movie;
automatically determining one or more theme elements from a plurality of theme elements based on a selected theme; and
automatically adding the one or more determined theme elements to the movie.

8. The method of claim 7, wherein automatically determining theme elements further comprises:
selecting a theme element based on the selected theme; and
adding content to the theme element.

9. The method of claim 8, wherein the content is derived from the raw video footage.

10. The method of claim 8, wherein the content is a still image.

11. The method of claim 8, wherein the content is added to a drop zone in a theme element.

12. The method of claim 7, further comprising:
automatically adding a title to the movie.

13. The method of claim 7, further comprising
automatically adding music to the movie.

14. The method of claim 13, further comprising
determining the music for adding to the movie based on the selected theme.

15. A computer-readable medium including instructions, which when executed by a processor, causes the processor to perform the operations of:
receiving a theme selection;
determining theme elements based on the theme selection;
receiving a theme element selection; and
adding the selected theme element to a movie.

16. A computer-readable medium including instructions, which when executed by a processor, causes the processor to perform the operations of:
automatically capturing raw video footage from a video source;
automatically dividing the raw video footage into video clips, wherein the video clips collectively constitute a movie;
automatically determining one or more theme elements from a plurality of theme elements based on a selected theme; and
automatically adding the one or more determined theme elements to the movie.

17. The computer-readable medium of claim 16, wherein automatically determining theme elements further comprises:
selecting a theme element based on the selected theme; and
adding content to the theme element.

18. The computer-readable medium of claim 17, wherein the content is derived from the raw video footage.

19. A system for authoring movies, comprising:
a user interface configured to display a first display area for displaying theme elements for selection and a second display area for adding selected theme elements to a movie; and
a rendering engine for rendering the selected theme elements into a movie.

20. A system for authoring a movie, comprising:
a processor;
a computer-readable medium operatively coupled to the processor and including instructions, which when executed by the processor, causes the processor to perform the operations of:
automatically capturing raw video footage from a video source;
automatically dividing the raw video footage into video clips, wherein the video clips collectively constitute a movie;
automatically determining one or more theme elements from a plurality of theme elements based on a selected theme; and
automatically adding the one or more determined theme elements to the movie.
